(19) United States
(12) Patent Application Publication
(10) Pub. No.: US 2026/0338353 A1
(43) Pub. Date: Oct. 29, 2026

(54) VEHICLE INTERIOR LIGHTING DEVICE

(71) Applicant: TOYOTA JIDOSHA KABUSHIKI KAISHA, Aichi-ken (JP)

(72) Inventors: Ippei KOBAYASHI, Toyota-shi (JP); Sho KANAMORI, Toyota-shi (JP)

(21) Appl. No.: 19/408,360

(22) Filed: Dec. 4, 2025

(30) Foreign Application Priority Data
Apr. 24, 2025 (JP) 2025-071980

(51) Int. Cl. F21V 11/02; B60Q 3/10; B60Q 3/217; B60Q 3/60; B60Q 3/72; F21V 7/00; F21W 106/00; F21Y 115/10

(52) U.S. Cl. CPC F21V 11/02; B60Q 3/10; B60Q 3/217; B60Q 3/60; B60Q 3/72; F21V 7/0008; F21W 2106/00; F21Y 2115/10

(57) ABSTRACT

The vehicle interior lighting device includes a light source, a reflection plate, and a vertical louver. The light source configures to emit decorative light. The reflection plate reflects and diffuses the decorative light toward a vehicle interior. The vertical louver faces a reflection surface of the reflection plate. The vertical louver blocks light reflected and scattered outwardly in the vehicle width direction.

### CROSS REFERENCE TO RELATED APPLICATION

This application claims priority to Japanese Patent Application No. 2025-71980, filed on Apr. 24, 2025, which is incorporated herein by reference in its entirety including the specification, claims, drawings, and abstract.

### TECHNICAL FIELD

The present specification discloses a vehicle interior lighting device.

### BACKGROUND

In JP 2005-271776 A, fins are attached to the instrument panel to improve the appearance of the instrument panel. A register that is long in the vehicle width direction is formed in the instrument panel. Fins are attached to the register to control the flow rate of air conditioning wind from the register.

A lighting device may be provided in a front portion of the vehicle interior. For example, an illumination device for illumination is provided on an instrument panel.

When decoration light is emitted from the illumination device to the vehicle interior, a part of the light may be reflected by the side glass of the front door. When the driver views the side mirror, the driver views the side mirror through the side glass. When the decoration light is reflected on the side glass, the mirror image of the side mirror and the reflected image of the side glass overlap each other, and the driver may feel bothersome.

Therefore, the present specification discloses a vehicle interior lighting device capable of illuminating a vehicle interior without causing a driver to feel bothersome when viewing a side mirror.

### SUMMARY

Disclosed herein is a vehicle interior lighting device. The vehicle interior lighting device includes a light source, a reflection plate, and a vertical louver. The light source configures to emit decorative light. The reflection plate reflects and diffuses the decorative light toward a vehicle interior. The vertical louver faces a reflection surface of the reflection plate. The vertical louver blocks light reflected and scattered outwardly in the vehicle width direction.

According to the above configuration, the decorative light incident on the outer side in the vehicle width direction is blocked by the vertical louver. Accordingly, the reflection of the decorative light on the side mirror is suppressed.

In the above configuration, the light source may emit the decorative light outwardly in the vehicle width direction. The reflection plate is disposed outward of the light source in the vehicle width direction. The reflection plate is tilted inward. That is, an outer end of the reflection plate in the vehicle width direction is tilted toward the vehicle interior. The vertical louver is disposed behind the reflection plate in the vehicle front-rear direction.

According to the above configuration, since the reflection plate is inclined inward, the reflected light and the scattered light are suppressed from being emitted outward in the vehicle width direction.

In the above configuration, the vertical louver may comprise a plurality of louver elements arranged along the vehicle width direction, the pitch between the adjacent louver elements becomes narrower toward the outer side in the vehicle width direction.

According to the above configuration, the light shielding effect on the outer side in the vehicle width direction of the vertical louver is improved as compared with that on the inner side in the vehicle width direction.

In the above configuration, the vertical louver may comprise a plurality of louver elements arranged along the vehicle width direction. The front-rear thickness of the louver elements nearer the outside of the vehicle in the width direction is greater than that of the louver elements nearer the center of the vehicle.

According to the above configuration, the light shielding effect on the outer side in the vehicle width direction of the vertical louver is improved as compared with that on the inner side in the vehicle width direction.

In the above configuration, the vertical louver may comprise a plurality of louver elements arranged along the vehicle width direction. The width of the louver elements nearer the outside of the vehicle in the width direction is greater than that of the louver elements nearer the center of the vehicle.

According to the above configuration, the light shielding effect on the outer side in the vehicle width direction of the vertical louver is improved as compared with that on the inner side in the vehicle width direction.

According to the vehicle interior lighting device disclosed in the present specification, it is possible to illuminate the vehicle interior without causing the driver to feel bothersome when viewing the side mirror.

### BRIEF DESCRIPTION OF DRAWINGS

Embodiments of the present disclosure will be described based on the following figures, wherein:

FIG. 1 is a diagram illustrating a structure near a passenger seat;

FIG. 2 is a plan view cross-sectional view illustrating the structure of the vehicle interior lighting device according to the present embodiment;

FIG. 3 is a front view of a vertical louver;

FIG. 4 is a view of the vertical louver as viewed from the outside of the side mirror;

FIG. 5 is a diagram illustrating a structure of a vertical louver;

FIG. 6 is a diagram illustrating a first different example (unequal pitch) of the vertical louver;

FIG. 7 is a diagram illustrating a second alternative example (unequal plate thickness) of the vertical louver; and

FIG. 8 is a diagram illustrating a second alternative example (unequal plate width) of the vertical louver.

### DESCRIPTION OF EMBODIMENTS

Hereinafter, a vehicle interior lighting device according to the present embodiment will be described with reference to the drawings. The shapes, materials, numbers, and numerical values described below are for illustrative purposes only. These shapes and the like can be appropriately changed according to the specifications of the vehicle interior lighting device. In the following description, the same reference numerals denote the same elements in all the drawings.

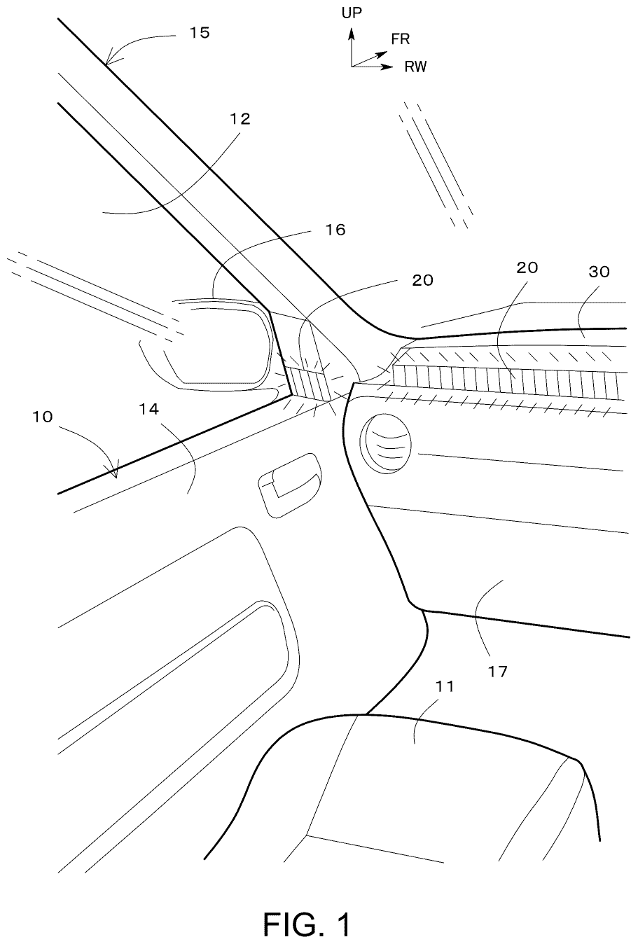

In FIGS. 1, 2, and 5 to 8, an orthogonal coordinate system including an FR axis, an RW axis, and an UP axis is used to represent the position and direction of each configuration. The FR axis is a vehicle front-rear direction axis whose forward direction is the vehicle front side. The RW axis is a vehicle width direction axis whose forward direction is the right side of the vehicle. The UP axis is a vehicle vertical axis whose upward direction is a positive direction.

### 1. Vehicle Cabin Configuration

FIG. 1 illustrates a vehicle cabin. In the example of FIG. 1, a structure around a passenger seat in a so-called right-hand drive vehicle is illustrated.

An instrument panel 30 is disposed in front of the passenger seat 11. A front door 10 is disposed outside the passenger seat 11 in the vehicle width direction. A door trim 14 is disposed on the vehicle interior side of the front door 10. A side glass 12 is disposed above the door trim 14. A side mirror 16 is disposed outside the side glass 12 in the vehicle width direction, that is, outside the vehicle cabin. The driver views the side mirror 16 through the side glass 12. That is, when the driver views the side mirror 16, the line of sight intersects with the side glass 12.

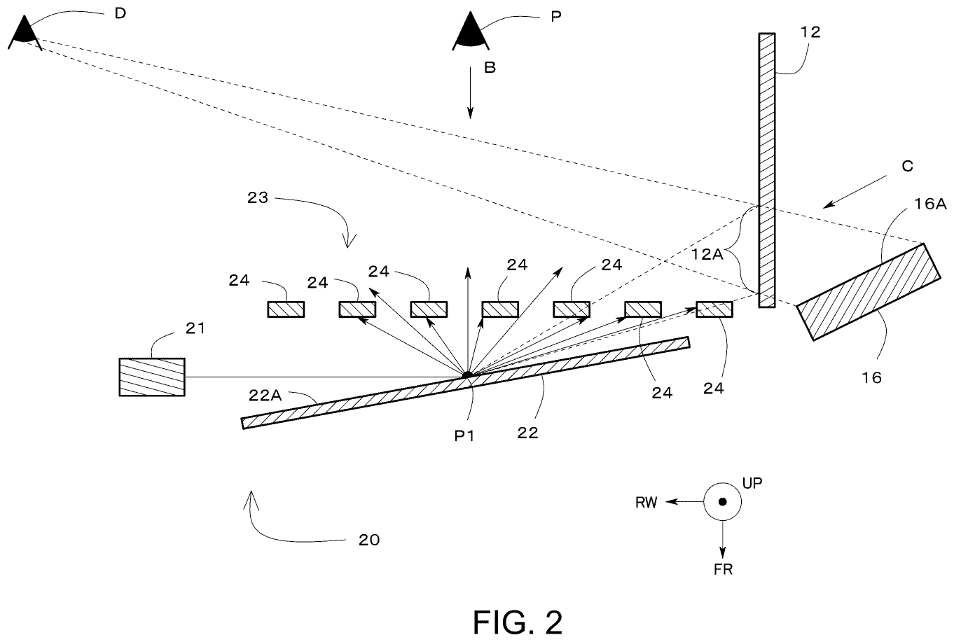

FIG. 2 schematically shows a plan view cross section of FIG. 1. The line of sight of the driver D passes through the side glass 12 and reaches the mirror surface 16A of the side mirror 16. If some kind of image is reflected in a region of the side glass 12 intersecting the line of sight of the driver D, the driver D feels bothersome when visually recognizing the image reflected on the mirror surface 16A of the side mirror 16.

Hereinafter, an intersection region between a line of sight when the driver D views the side mirror 16 and the side glass 12 is referred to as a reflection suppression area 12A. In the lighting device 20, incidence of decorative light on the reflection suppression area 12A is suppressed by the vertical louver 23. Details of this suppression mechanism will be described later.

Referring to FIG. 1, a lighting device 20 according to the present embodiment is disposed in a vehicle cabin. The lighting device 20 illuminates the interior of the vehicle with decorative light. For example, the lighting device 20 is disposed in front of the vehicle cabin. For example, the lighting device 20 is disposed in the front door 10. More specifically, the lighting device 20 is disposed at the lower end portion of the A pillar 15. For example, the lighting device 20 is disposed at the same height as the side mirror 16.

The lighting device 20 may be disposed on the instrument panel 30. For example, the lighting device 20 is disposed above the glove box 17. Also in this case, the lighting device 20 is installed at the same height as the side mirror 16.

### 2. Lighting Device

FIG. 2 schematically illustrates a planar cross section of the lighting device 20. The lighting device 20 includes a light source 21, a reflection plate 22, and a vertical louver 23. The light source 21 is, for example, an LED lamp. The light source 21 emits decorative light. For example, the light source 21 emits decorative light outward in the vehicle width direction.

The reflection plate 22 reflects and diffuses the decorative light toward the vehicle interior. As illustrated in FIG. 2, the reflection plate 22 is disposed outside the light source 21 in the vehicle width direction. The decorative light emitted from the light source 21 is reflected and scattered at the reflection point P1 of the reflection surface 22A. The reflected light and the scattered light are emitted into the vehicle interior.

The reflection plate 22 is disposed so as to be inclined inward. That is, the vehicle width direction outer side of the reflection plate 22 is disposed closer to the vehicle cabin side (in other words, rearward in the vehicle longitudinal direction) than the vehicle width direction inner side. The reflection surface 22A of the reflection plate 22 faces the vehicle cabin. For example, the reflection surface 22A faces rearward in the vehicle front-rear direction. Since the reflection plate 22 and the reflection surface 22A are disposed so as to face inward, reflected light and scattered light toward the outside in the vehicle width direction are suppressed.

The vertical louver 23 faces the reflection surface 22A of the reflection plate 22. For example, as illustrated in FIG. 2, a vertical louver 23 is disposed behind the reflection plate 22 in the vehicle front-rear direction. That is, the vertical louver 23 is disposed between the reflection surface 22A and the vehicle cabin. A part of the reflected light and scattered light generated by the reflection surface 22A passes through the vertical louver 23 and enters the vehicle interior. The other part is blocked by the vertical louver 23. As will be described later, the vertical louver 23 blocks reflected light and scattered light toward the outside in the vehicle width direction.

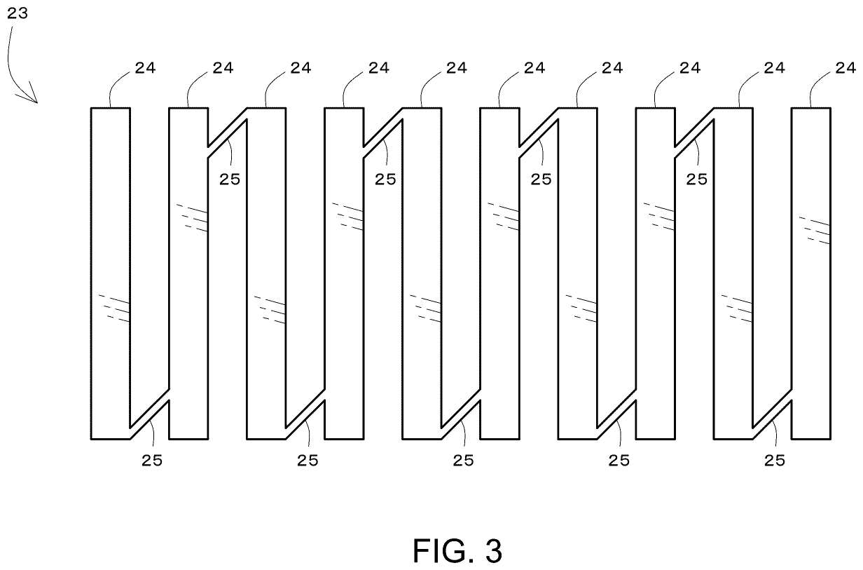

The vertical louver 23 includes a plurality of louver elements 24. The louver elements 24 are arranged at intervals along the vehicle width direction. The louver elements 24 are erected along the up-down direction (vertical direction). As illustrated in FIG. 3, the vertical louver 23 is integrally formed of a non-translucent resin. For example, the plurality of louver elements 24 are connected by a bridge 25.

Referring to FIG. 2, the louver elements 24 have a predetermined thickness (a dimension in the vehicle front-rear direction). This thickness changes the appearance of the vertical louver 23 depending on the viewing angle.

In FIG. 2, the vertical louver 23 when viewed from the occupant P of the passenger seat 11 (see arrow B) is illustrated in FIG. 3. That is, FIG. 3 shows an example when the vertical louver 23 is viewed from the front. When the vertical louver 23 is viewed from the front, a gap is formed between the adjacent louver elements 24 and 24. Decoration light (reflected light and scattered light) is emitted from the gap into the vehicle interior.

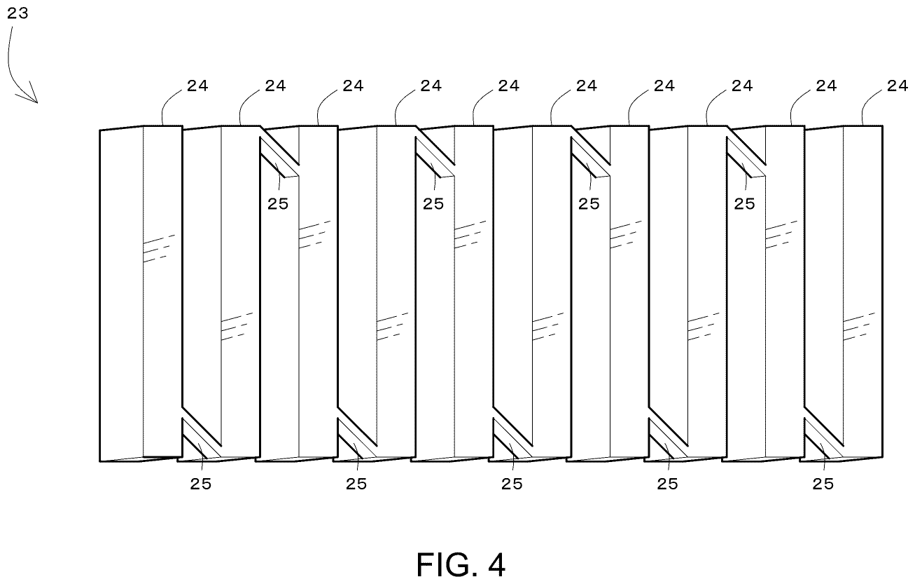

In FIG. 2, as indicated by an arrow C, FIG. 4 illustrates a state in which the vertical louver 23 is viewed from the outside of the vehicle through the reflection suppression area 12A. As shown in FIG. 4, when the vertical louver 23 is viewed obliquely, the gap between the louver elements 24, 24 is closed by the thickness of the louver elements 24. That is, the decorative light (reflected light and scattered light) emitted from the reflection plate 22 is blocked by the vertical louver 23. Therefore, the reflection of the decorative light in the reflection suppression area 12A is suppressed.

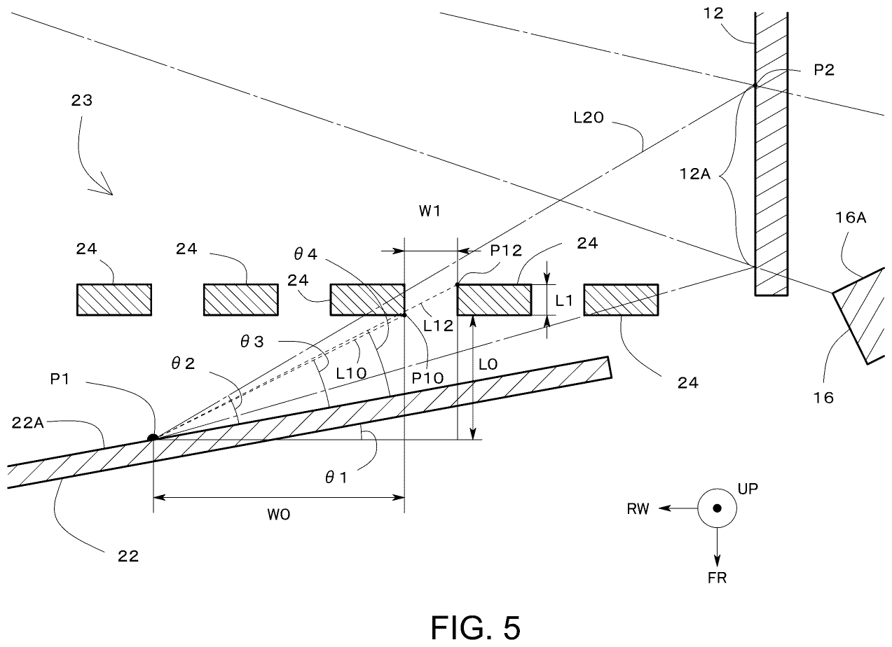

FIG. 5 illustrates the structure of the lighting device 20. The angle θ1 indicates an angle of the reflection surface 22A with respect to the vehicle width direction axis RW. The angle θ2 indicates an angle formed by the straight line L20 and the reflection surface 22A. The straight line L20 connects the reflection point P1 and the boundary P2 of the reflection suppression area 12A. The angle θ3 indicates an angle formed by the straight line L10 and the reflection surface 22A. The straight line L10 connects the vertex P10 of the louver elements 24 on the outer side and the front side in the vehicle width direction and the reflection point P1. The angle θ4 indicates an angle formed by the straight line L12 and the reflection surface 22A. The straight line L12 connects the reflection point P1 to the vertex P12 on the vehicle width direction inner side and the rear side of the louver elements 24 disposed on the vehicle width direction outer side with the pitch W1 therebetween. As shown in the figure, the magnitude relations of the respective angles are 0° and 02 and 90°, 0° and θ3 and 0° and θ4 and θ2, respectively.

In the example of FIG. 5, all the louver elements 24 are arranged at a constant pitch W1 in the vehicle width direction. All the louver elements 24 have the same thickness L1. The distance W0 indicates a distance along the vehicle width direction from the reflection point P1 to the vertex P10. Further, the distance L0 indicates a distance from the reflection point P1 to the front surface of the louver elements 24. Using these parameters, the following formulas (1) and (2) are established.

$$\begin{matrix}[ Formula 1 ] & \\ tan ( {θ}_{1} + {θ}_{3} ) = \frac{{L}_{0}}{{W}_{0}} & ( 1 )\end{matrix}$$

$$\begin{matrix}[ Formula 2 ] & \\ tan ( {θ}_{1} + {θ}_{4} ) = \frac{{L}_{0} + {L}_{1}}{{W}_{0} + {W}_{1}} & ( 2 )\end{matrix}$$

When θ3≤θ4, the vertical louver 23 blocks the decoration light to the reflection suppression area 12A. In this case, tan (θ3)≤tan (θ4) is derived from 0° Δ3<90° and 0° Δ4<90°. Further, if θ3≤θ4 is satisfied due to θ1 Δ2<90°, 0° Δ3, θ2, and 0° Δ4, tan (θ1 Δ3)≤tan (θ1 Δ4). From this relationship and the formulas (1) and (2), the following formula (3) is obtained.

$$\begin{matrix}[ Formula 3 ] & \\ \frac{{L}_{0}}{{W}_{0}} ≦ \frac{{L}_{0} + {L}_{1}}{{W}_{0} + {W}_{1}} & ( 3 )\end{matrix}$$

The following formula (4) is obtained by organizing the formula (3). The vertical louver 23 is installed in the vehicle so as to satisfy the following formula (4). Accordingly, the reflection of the decorative light (reflected light and scattered light) in the reflection suppression area 12A is avoided.

$$\begin{matrix}[ Formula 4 ] & \\ \frac{{L}_{0}}{{W}_{0}} ≦ \frac{{L}_{1}}{{W}_{1}} & ( 4 )\end{matrix}$$

### 3. Other Examples of Lighting Devices

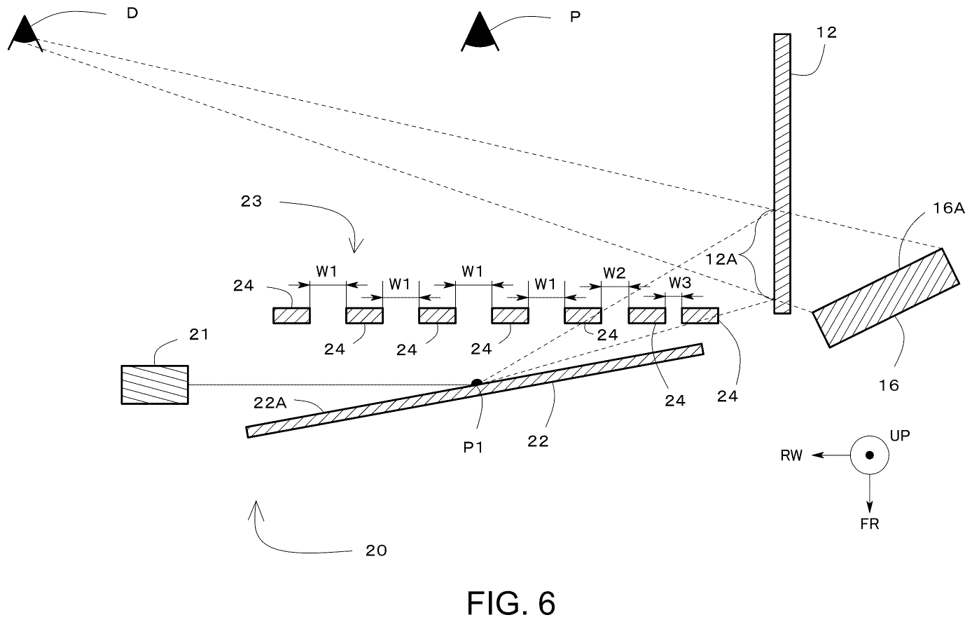

FIG. 6 shows a first alternative example (unequal pitch) of the vertical louver 23. In this example, the pitch W1 in formula (4) is shortened on the outer side in the vehicle width direction. That is, the outer pitches W2 and W3 in the vehicle width direction are set to be narrower than the inner pitch W1 in the vehicle width direction. Further, the outermost pitch W3 in the vehicle width direction is set to a value narrower than the inner pitch W2. With such a pitch setting, the reflection of the decorative light on the reflection suppression area 12A is suppressed with high accuracy.

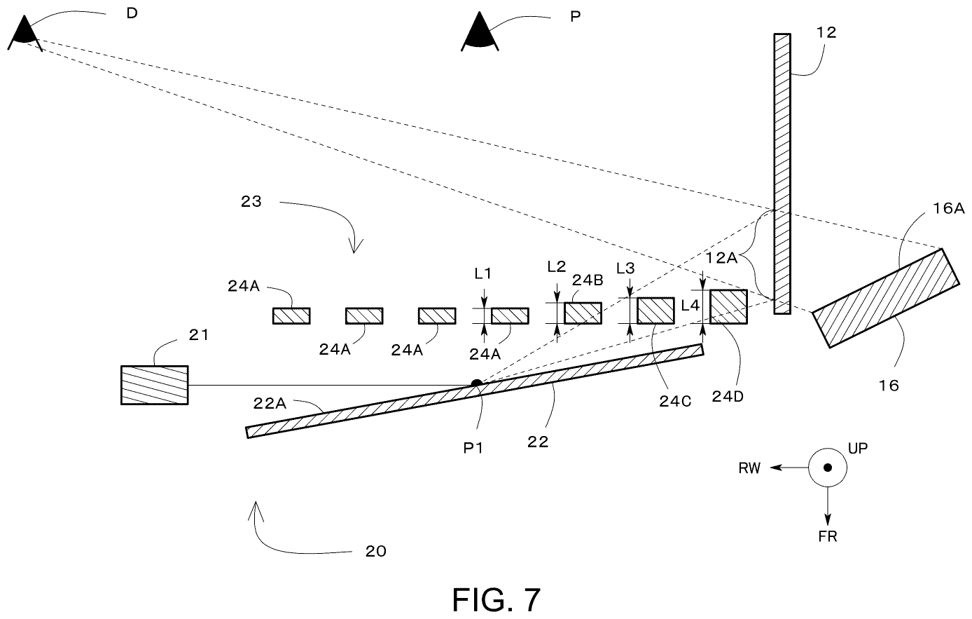

FIG. 7 shows a second alternative example (unequal plate thickness) of the vertical louver 23. In this example, a plate thickness (a dimension in the vehicle front-rear direction) L1 in formula (4) of the louver elements nearer the outside of the vehicle in the width direction is greater than that of the louver elements nearer the center of the vehicle. That is, the plate thicknesses L2, L3, and L4 of the louver elements 24B, 24C, and 24D on the outer sides in the vehicle width direction are set to be thicker than the plate thickness L1 of the louver elements 24A on the inner side in the vehicle width direction. Further, the plate thicknesses L2, L3, and L4 are determined so that the thickness of the louver elements 24 on the outer side in the vehicle width direction becomes thicker. That is, the louver elements 24B, 24C, and 24D are formed so that the plate thickness L2<L3<L4. That is, the louver elements 24B, 24C, and 24D on the outer sides in the vehicle width direction are longer in the vehicle front-rear direction than the louver element 24A on the inner sides in the vehicle width direction. By setting the plate thickness in this manner, the reflection of the decorative light on the reflection suppression area 12A is suppressed with high accuracy.

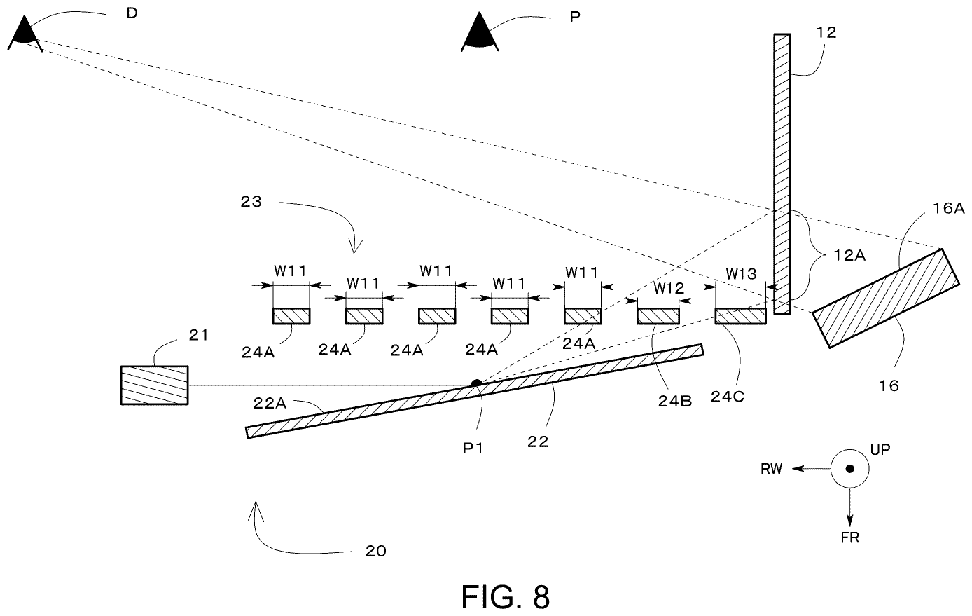

FIG. 8 shows a third variation (unequal plate width) of the vertical louver 23. In this example, the widths (dimensions in the vehicle width direction) W12 and W13 of the louver elements 24B and 24C on the outer sides in the vehicle width direction are set to be wider (longer) than the width W11 of the louver elements 24A on the inner side in the vehicle width direction. Further, the plate widths W12 and W13 are determined so that the width becomes wider toward the outer side in the vehicle width direction of the louver elements 24. That is, the louver elements 24B and 24C are formed so that the plate width W12 is smaller than the plate width W13.

With such a configuration, the pitch W1 in formula (4) is shortened on the outer side in the vehicle width direction. Accordingly, the reflection of the decorative light on the reflection suppression area 12A is suppressed with high accuracy.

The present disclosure is not limited to the present embodiments described above, and includes all changes and modifications without departing from the technical scope or the essence of the present disclosure defined by the claims.

1. A vehicle interior lighting device comprising:
a light source configured to emit decorative light;
a reflection plate reflecting and diffusing the decorative light toward a vehicle interior; and
a vertical louver facing a reflection surface of the reflection plate, wherein the vertical louver blocks light reflected and scattered outwardly in the vehicle width direction.

2. The vehicle interior lighting device according to claim 1, wherein
the light source emits the decorative light outwardly in the vehicle width direction;
the reflection plate is disposed outward of the light source in the vehicle width direction, and the reflection plate is tilted inward such that an outer end of the reflection plate in the vehicle width direction is tilted toward the vehicle interior; and
the vertical louver is disposed behind the reflection plate in the vehicle front-rear direction.

3. The vehicle interior lighting device according to claim 2, wherein
the vertical louver comprises a plurality of louver elements arranged along the vehicle width direction; and
the pitch between the adjacent louver elements becomes narrower toward the outer side in the vehicle width direction.

4. The vehicle interior lighting device according to claim 2, wherein
the vertical louver comprises a plurality of louver elements arranged along the vehicle width direction; and
the front-rear thickness of the louver elements nearer the outside of the vehicle in the width direction is greater than that of the louver elements nearer the center of the vehicle.

5. The vehicle interior lighting device according to claim 2, wherein
the vertical louver comprises a plurality of louver elements arranged along the vehicle width direction; and
the width of the louver elements nearer the outside of the vehicle in the width direction is greater than that of the louver elements nearer the center of the vehicle.
